(19) United States
(12) Patent Application Publication
(10) Pub. No.: US 2025/0239224 A1
(43) Pub. Date: Jul. 24, 2025

(54) DISPLAY PANEL AND DISPLAY DEVICE INCLUDING THE SAME

(71) Applicant: LG Display Co., Ltd., Seoul (KR)

(72) Inventors: Jaewoo KIM, Gimpo-si (KR); Junho BONG, Gimpo-si (KR)

(73) Assignee: LG Display Co., Ltd., Seoul (KR)

(21) Appl. No.: 19/005,064

(22) Filed: Dec. 30, 2024

(30) Foreign Application Priority Data
Jan. 23, 2024 (KR) 10-2024-0010371

(51) Int. Cl. G09G 3/3233

(52) U.S. Cl. CPC G09G 3/3233; G09G 2300/0819; G09G 2300/0852; G09G 2300/0861; G09G 2310/08; G09G 2320/0233; G09G 2320/045

(57) ABSTRACT

Disclosed is a display panel in which a sampling transistor and a sampling capacitor for additional sampling are disposed between a light-emitting element and a driving element of the display panel to secure a sufficient sampling time of the driving element. Further, a display device including the panel is disclosed. To this end, a first switching element is configured to be switched to apply an initialization voltage to each of a first electrode of the light-emitting element and a gate electrode of the driving element; and a second switching element is configured to be switched to apply a sampling voltage to a second electrode and the gate electrode of the driving element. Thus, a sufficient sampling time of a threshold voltage of the driving element is secured such that pixel defects such as luminance non-uniformity of pixels are reduced.

### CROSS-REFERENCE TO RELATED APPLICATIONS

This application claims the benefit of and priority to Korean Patent Application No. 10-2024-0010371 filed on Jan. 23, 2024 in the Korean Intellectual Property Office, and all the benefits accruing therefrom under 35 U.S.C. 119. The entirety of the foregoing application is incorporated herein by reference for all purposes.

### BACKGROUND

### 1. Technical Field

The present disclosure relates to a display panels and a display device, and particularly to, for example, without limitation, a display panel in which pixels emit light in a uniform manner to reduce a pixel defect such as luminance non-uniformity and a display device including the same.

### 2. Description of the Related Art

An organic light-emitting element (Organic Light Emitting Diode: OLED) includes an anode electrode and a cathode electrode, and an organic compound layer formed therebetween. The organic compound layer is composed of a hole transport layer (HTL), a light-emitting layer (EML), and an electron transport layer (ETL).

An organic light-emitting display device includes pixels arranged in a matrix form, each including an organic light-emitting element. A luminance level of each of the pixels is controlled based on a gray level of image data. Each of the pixels includes the organic light-emitting element, a driving transistor that controls a driving current flowing through the organic light-emitting element based on a difference (gate-source voltage) between a voltage of a gate and a voltage of a source thereof, and at least one switch transistor that programs the gate-source voltage of the driving transistor. The organic light-emitting element, and a pixel circuit including the driving transistor, and the at least one switch transistor operate based on a scan signal and a light-emission signal.

The description of the related art should not be assumed to be prior art merely because it is mentioned in or associated with this section. The description of the related art includes information that describes one or more aspects of the subject technology, and the description in this section does not limit the invention.

### SUMMARY

In one or more example embodiments of the present disclosure, an organic light-emitting display device applies scan signals SC1, SC2, SC3, and SC4 to the pixel circuit through a scan line, applies a light-emission signal EM thereto through a light-emission line, and supplies power signals VOBS, Vini, and VAR thereto through a power line.

Recently, the demand for high-resolution display devices has been increasing. As the resolution increases, the pixels per inch (PPI) also rise. Consequently, a horizontal period (which may be referred to as 1TH) maintained for one frame is reduced, which is a disadvantage.

As the 1TH is reduced in this way, an existing diode connection model has the disadvantage in which a sampling time (Vth Sampling Time) of a threshold voltage of the driving transistor is reduced.

Therefore, because the sampling time of the threshold voltage of the driving transistor is reduced, compensation is not properly performed, resulting in defects such as luminance non-uniformity.

The inventors of the present disclosure have recognized the problems and needs of the related art, including the aforementioned problems, have performed extensive research and experiments, and have developed a new display panel in which a transistor for additional sampling is added to the display panel to secure a sufficient sampling time of the threshold voltage of the driving transistor, and a display device including the same.

Accordingly, one or more aspects and purposes of the present disclosure are directed to providing a display panel in which a sampling transistor and a sampling capacitor for additional sampling are disposed between a light-emitting element and a driving element of the display panel to secure a sufficient sampling time of the threshold voltage of the driving element, and a display device including the same.

Aspects and purposes of the present disclosure are not limited to the above-mentioned aspects and purposes. Other aspects, purposes and advantages of the present disclosure are set forth in the present disclosure and will also be apparent from the present disclosure or may be learned by practice of the inventive concepts provided herein. Further, other aspects, purposes and advantages of the present disclosure may be realized and attained by the descriptions provided in the present disclosure, including the claims and the drawings.

In a display device according to one or more example embodiments of the present disclosure, a switching element may be switched so that an initialization voltage is applied to each of a first electrode of a light-emitting element and a gate electrode of the driving element. Another switching element may be switched so that a sampling voltage is applied across a first electrode and the gate electrode of the driving element.

Furthermore, in a display device according to one or more example embodiments of the present disclosure, an initialization voltage is applied to each of a first electrode of a light-emitting element and a gate electrode of a driving element through a switching element. A sampling voltage is applied across a first electrode and the gate electrode of the driving element through another switching element. A light-emission driver may supply a light-emission signal to the switching element, and a scan driver may supply a scan signal to the another switching element.

Specific details of one or more example embodiments are included in the detailed description and drawings.

The technical solutions according to one or more example embodiments of the present disclosure are not limited to those as mentioned above. Other technical solutions not mentioned above may be clearly understood by those skilled in the art from the present disclosure.

According to one or more example embodiments of the present disclosure, even in high-resolution models, a sampling transistor for additional sampling is added to the display panel to secure a sufficient sampling time of the threshold voltage of the driving transistor.

This may reduce the pixel defect such as luminance non-uniformity of the pixels.

In the display device according to one or more example embodiments of the present disclosure, the second scan signal SC2 are applied twice. That is, the n-th second scan signal is applied to one transistor, and the (n−1)-th second scan signal is applied to another transistor. Thus, a sufficient sampling time of the threshold voltage of the driving transistor, based on the voltage across the gate electrode and the source electrode of the driving transistor, may be secured. That is, the threshold voltage of the driving transistor can be sampled for a sufficient amount of time, where the threshold voltage is based on the voltage across the gate electrode and the source electrode of the driving transistor. Thus, the threshold voltage of the driving transistor may be compensated for based on the sampling result, and the data voltage may be applied to the gate node of the driving transistor. Thus, pixel defects may be reduced.

Furthermore, according to one or more example embodiments of the present disclosure, pixel defects may be reduced, thereby improving a lifespan of each of the display panel and the display device including the same.

Furthermore, according to one or more example embodiments of the present disclosure, the luminance levels of the pixels may be uniform by preventing the sampling time of the threshold voltage of the driving transistor from being reduced. Thus, an image display quality of the pixel may be improved.

Furthermore, according to one or more example embodiments of the present disclosure, the image display quality of the pixel may be improved such that the quality of a display device may be improved, and the reliability thereof may be secured, thereby achieving a narrow bezel.

Effects of the present disclosure are not limited to the effects mentioned above, and other effects not mentioned will be clearly understood by those skilled in the art from the present disclosure.

In addition to the above effects, other specific effects of the present disclosure are described herein while describing specific example details for carrying out the subject technology.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### BRIEF DESCRIPTION OF THE DRAWINGS

The accompanying drawings, which are included to provide a further understanding of the disclosure, are incorporated in and constitute a part of this disclosure, illustrate aspects and embodiments of the disclosure, and together with the description serve to explain principles and examples of the disclosure.

FIG. 1 is a block diagram schematically showing a display device according to one or more example embodiments of the present disclosure.

FIG. 2 is a diagram showing a pixel circuit of a display device according to one or more example embodiments of the present disclosure.

FIG. 3 is a cross-sectional view showing a stack structure of a display device according to one or more example embodiments of the present disclosure.

FIG. 4 is a diagram of a configuration of a gate driver in a display device according to one or more example embodiments of the present disclosure.

FIG. 5 is a diagram for illustrating application of a scan signal and a light-emission signal in a pixel circuit according to one or more example embodiments of the present disclosure.

FIG. 6 is an operation timing graph showing a sampling period of a driving element according to one or more example embodiments of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that each of the terms “comprise,” “comprising,” “include,” “including,” “have,” “having,” “contain,” “containing,” “made of,” “formed of,” “composed of,” or the like specifies the presence of the stated features, integers, operations, elements, and/or components, but does not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to,” or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

In descriptions of temporal relationships, for example, temporal precedent relationships between two events such as “after,” “subsequent to,” “before,” etc., another event may occur therebetween unless “directly after,” “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first,” “second,” “third,” and so on may be used herein to describe various elements, components, regions, layers, sections and/or periods, these elements, components, regions, layers, sections and/or periods should not be limited by these terms. These terms are used to distinguish one element, component, region, layer, section or period from another element, component, region, layer, section or period. Thus, a first element, component, region, layer, section or period as described herein could be termed a second element, component, region, layer, section or period, without departing from the spirit and scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements.

When an embodiment may be implemented differently, functions or operations specified within a specific block may be performed in a different order from an order specified in a flowchart. For example, two consecutive blocks may actually be performed substantially simultaneously, or the blocks may be performed in a reverse order depending on related functions or operations.

The features of the various embodiments of the present disclosure may be partially or entirely combined with each other, and may be technically associated with each other or operate with each other. The embodiments may be implemented independently of each other and may be implemented together in an association relationship.

In interpreting a numerical value, the value is interpreted as including an error range unless there is no separate explicit description thereof.

It will be understood that when an element or layer is referred to as being “connected to,” or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects,” and the like should not be construed such that any aspect or design as described is superior to or advantageous over other aspects or designs.

Further, the term “or” means “inclusive or” rather than “exclusive or.” That is, unless otherwise stated or clear from the context, the expression that “x uses a or b” means any one of natural inclusive permutations.

The terms used herein have been selected as being general and universal in the related technical field. However, there may be other terms than the terms depending on the development and/or change of technology, convention, preference of technicians, etc. Therefore, the terms used herein should not be understood as limiting technical ideas, but should be understood as examples of the terms for illustrating embodiments.

Further, in a specific case, a term may be arbitrarily selected by the applicant, and in this case, the detailed meaning thereof is described herein. Therefore, the terms used herein should be understood based on not only the name of the terms, but also the meaning of the terms and the contents hereof.

In description of flow of a signal, for example, when a signal is delivered from a node A to a node B, this may include a case where the signal is transferred from the node A to the node B via another node unless a phrase “immediately transferred” or “directly transferred” is used.

Throughout the present disclosure, “A and/or B” means A, B, or A and B, unless otherwise specified, and “C to D” means C inclusive to D inclusive unless otherwise specified.

“At least one” should be understood to include any combination of one or more of listed components. For example, at least one of first, second, and third components means not only a first, second, or third component, but also all combinations of two or more of the first, second, and third components.

As used herein, the term “display apparatus” may include, in a narrow sense, a display apparatus including a liquid crystal module (LCM), an organic light-emitting diode (OLED) module, or a quantum dot (QD) module including a display panel and a driver for driving the display panel. Moreover, the display apparatus may include, in a broad sense, a laptop computer, a television, a computer monitor, an automotive device or an equipment display for a vehicle, a set electronic device, a set device or a set device including a complete product or a final product including the LCM, the OLED module, or the QD module.

Therefore, the display apparatus in accordance with one or more example embodiments of the present disclosure may include, in the narrow sense, a display apparatus itself including, for example, the LCM, the OLED module, QD module, etc., and may include, in a broad sense, the set device as an application product or an end-user device including a complete product or a final product including the LCM, the OLED module, or the QD module.

Moreover, in some cases, the LCM, OLED module, or QD module composed of the display panel and the driver may be expressed as “display apparatus” in a narrow sense. The electronic device as a complete product including the LCM, OLED module or QD module may be expressed as “set device” in a broad sense. For example, the display apparatus in the narrow sense may include a display panel such as a liquid crystal panel, an organic light-emitting display panel, or a quantum dot display panel, and a source PCB as a controller for driving the display panel. The set device in the broad sense may include a display panel such as a liquid crystal panel, an organic light-emitting display panel, or a quantum dot display panel, a source PCB as a controller for driving the display panel, and a set PCB as a set controller that is electrically connected to the source PCB and controls the set device.

As used herein, the display panel may be of any type of the display panels such as a liquid crystal display panel, an organic light emitting diode (OLED) display panel, a quantum dot (QD) display panel, and an electroluminescent display panel, etc. The display panel used in the disclosure may be not limited to a specific display panel including a flexible substrate for the OLED display panel and an underlying back plate support structure and having a bendable bezel. Moreover, the display panel used in the display apparatus according to one or more example embodiments of the present disclosure is not limited to a shape or a size of the display panel.

More specifically, when the display panel is embodied as the organic light emitting diode (OLED) display panel, the display panel may include a plurality of gate lines and data lines, and pixels respectively formed in areas where the gate lines and the data lines intersect with each other. Moreover, the display panel may be configured to include an array including a thin-film transistor as an element for selectively applying a voltage to each pixel, an organic light-emitting element layer on the array, and an encapsulation substrate or an encapsulation layer disposed on the array to cover the organic light-emitting element layer. The encapsulation layer protects the thin-film transistor and the organic light-emitting element layer from external impact, and may prevent moisture or oxygen from penetrating into the organic light-emitting element layer. Moreover, the light emitting layer formed on the array may include an inorganic light emitting layer, for example, a nano-sized material layer, or a quantum dot.

Hereinafter, one or more example embodiments of the present disclosure will be described using the attached drawings. A scale of each of components as shown in the drawings is different from an actual scale thereof for convenience of illustration, and therefore, the present disclosure is not limited to the scale as shown in the drawings.

Hereinafter, a display panel and a display device including the same according to one or more example embodiments of the present disclosure will be described with reference to the drawings.

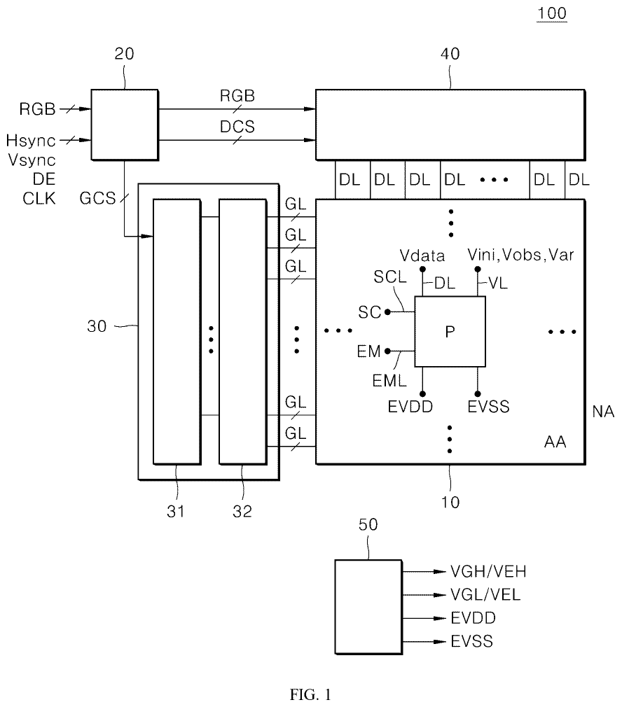

FIG. 1 is a block diagram schematically showing a display device according to one or more example embodiments of the present disclosure.

Referring to FIG. 1, a display device 100 according to one or more example embodiments of the present disclosure may include a display panel 10, a controller 20, a gate driver 30, a data driver 40, and a power supply 50.

The display panel 10 includes a plurality of pixels P. The display panel 10 may include a display area AA where the plurality of pixels P is located, and a non-display area NA surrounding the display area. The gate driver 30, the data driver 40, and the controller 20 are disposed in the non-display area NA.

The controller 20 controls the gate driver 30 and the data driver 40.

The gate driver 30 supplies a gate signal to the display panel 10.

The data driver 40 supplies a data signal to the display panel 10.

The power supply 50 supplies a power necessary to drive the display panel 10 thereto.

In the display panel 10, a plurality of gate lines GL and a plurality of data lines DL intersect each other, and each of the plurality of pixels P are connected to the gate line GL and the data line DL. Specifically, one pixel P receives the gate signal from the gate driver 30 through the gate line GL, and receives the data signal from the data driver 40 through the data line DL, and receives a high potential driving voltage EVDD and a low potential driving voltage EVSS from the power supply 50 through a power supply line (not shown).

In this regard, the gate line GL supplies a scan signal SC and a light-emission control signal EM to the pixel and the data line DL supplies a data voltage Vdata to the pixel. Furthermore, according to various embodiments, the gate line GL may include a plurality of scan lines SCL that supply the scan signal SC and a light-emission control signal line EML that supplies the light-emission control signal EM. Furthermore, the plurality of pixels P may additionally include a power line VL and may receive a bias voltage Vobs, an anode reset voltage Var, and an initialization voltage Vini through the power line VL.

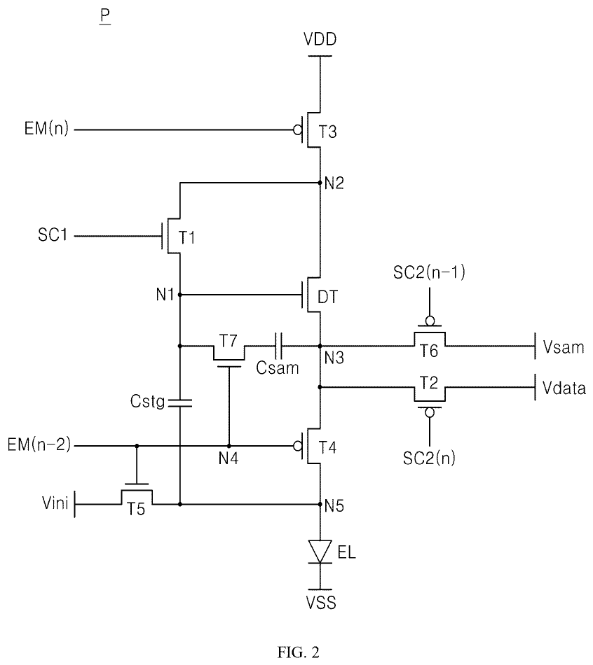

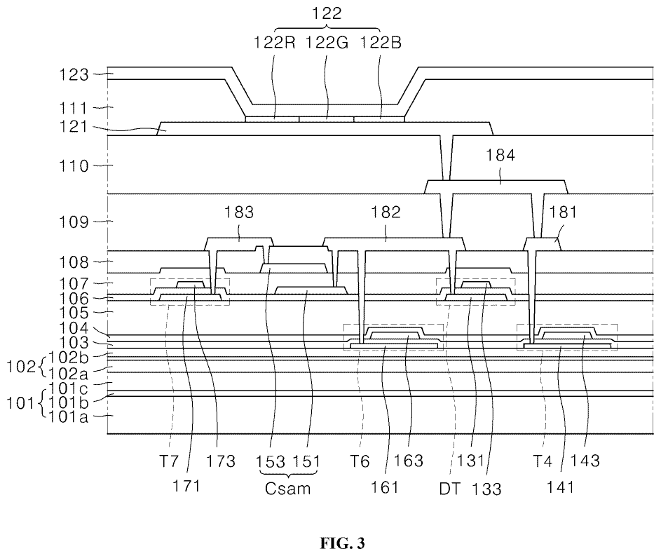

Furthermore, each pixel P includes a light-emitting element EL and a pixel circuit that controls an operation of the light-emitting element EL as shown in FIG. 2. In this regard, the light-emitting element EL is composed of an anode electrode 121, a cathode electrode 123, and a light-emitting layer 122 between the anode electrode 121 and the cathode electrode 123, as shown in FIG. 3.

The pixel circuit includes a plurality of switching elements, a driving element, and a capacitor. In this regard, each of the switching element and the driving element may be embodied as a thin-film transistor. In the pixel circuit, the driving element controls an amount of current supplied to the light-emitting element EL based on the data voltage to adjust an amount of light emitted from the light-emitting element EL. Furthermore, the plurality of switching elements receives a scan signal SC supplied through a plurality of scan lines SCL and a light-emission control signal EM supplied through a light-emission control signal line EML, and operates the pixel circuit based on the scan signal SC and the light-emission control signal EM. As used herein, the light-emission control signal EM may be simply referred to as “light-emission signal EM.” The light-emission control signal line EML may simply be referred to as “light-emission line.”

The display panel 10 may be embodied as a non-transmissive display panel or a transmissive display panel. The transmissive display panel may be applied to a transparent display device where an image is displayed on a screen and a real object in a background is visible to a viewer in front of the display device. The display panel 10 may be manufactured as a flexible display panel. The flexible display panel may be embodied as an OLED panel using a plastic substrate.

The pixels P may include a red pixel, a green pixel, and a blue pixel to emit light of corresponding colors. The pixels P may further include a white pixel. Each of the pixels P includes a pixel circuit.

Touch sensors may be disposed on the display panel 10. Touch input may be sensed using separate touch sensors or may be sensed through the pixels P. The touch sensors may be disposed on the screen of the display panel in an on-cell type or add-on type or may be embodied as in-cell type touch sensors built into the display panel 10.

The controller 20 processes image data RGB input from an external source such as a host system so as to be adapted to a size and a resolution of the display panel 10 and supplies the processed image data to the data driver 40. The controller 20 generate a gate control signal GCS and a data control signal DCS based on synchronization signals, for example, a clock signal CLK, a data enable signal DE, a horizontal synchronization signal Hsync, and a vertical synchronization signal Vsync input from the external source, and supplies the generated gate control signal GCS and data control signal DCS to the gate driver 30 and the data driver 40, respectively, thereby controlling the gate driver 30 and the data driver 40.

The controller 20 may be configured to be coupled to various processors, for example, a microprocessor, a mobile processor, an application processor, etc., depending on a type of a device on which the controller is mounted. The controller 20 may be a timing controller.

The host system may be any one of a television (TV) system, a set top box, a navigation system, a personal computer (PC), a home theater system, a mobile device, a wearable device, and a vehicle system.

The controller 20 multiplies an input frame frequency by i and controls an operation timing of each of the gate driver 30 and the data driver 40 using a frame frequency=the input frame frequency×i (i is a positive integer greater than 0) Hz. The input frame frequency is 60 Hz in the National Television Standards Committee (NTSC) scheme and is 50 Hz in the Phase-Alternating Line (PAL) scheme.

The controller 20 generates a signal so that the pixel may operate at various refresh rates. That is, the controller 20 generates operation-related signals such that the pixel may operate in a Variable Refresh Rate (VRR) mode or a refresh rate thereof may be switchable between a first refresh rate and the second refresh rate. For example, the controller 20 may simply change a rate of a clock signal, may generate a synchronization signal to generate a horizontal blank or a vertical blank, or may operate the gate driver 30 in a mask manner such that the pixel P may operate at various refresh rates.

The controller 20 generates, based on the timing signals Vsync, Hsync, and DE received from the host system, the gate control signal GSC for controlling the operation timing of the gate driver 30, and the data control signal DSC for controlling the operation timing of the data driver 40. The controller 20 controls the operation timings of the gate driver 30 and the data driver 40 to synchronize the gate driver 30 and the data driver 40 with each other.

A level shifter (not shown) converts a voltage level of the gate control signal GSC output from the controller 20 into a gate on voltage VGL and VEL and a gate off voltage VGH and VEH which in turn are supplied to the gate driver 30. The level shifter converts a low level voltage of the gate control signal GSC to a gate low voltage VGL, and converts a high level voltage of the gate control signal GSC to a gate high voltage VGH. The gate control signal GSC includes a start pulse and a shift clock.

The gate driver 30 supplies the scan signal SC to the gate line GL according to the gate control signal GCS supplied from the controller 20. The gate driver 30 may be disposed at one side or each of both opposing sides of the display panel 10 and in a GIP (Gate In Panel) manner.

The gate driver 30 sequentially outputs the gate signal to the plurality of gate lines GL under control of the controller 20. The gate driver 30 may shift the gate signal using a shift register and sequentially supply the shifted gate signal to the gate lines GL.

The gate signal may include the scan signal SC and the light-emission control signal EM in an organic light-emitting display device. The scan signal SC includes a scan pulse swinging between the gate on voltage VGL and the gate off voltage VGH. The light-emission control signal may include a light-emission control signal pulse that swings between the gate on voltage VEL and the gate off voltage VEH.

The scan pulse is synchronized with the data voltage Vdata to select pixels of a line to which the data voltage is to be written. The light-emission control signal EM may define a light-emission time of each of pixels. The light-emission control signal or light-emission signal EM may be a switching signal that turns on each transistor.

The gate driver 30 may include a light-emission control signal driver 31 and at least one scan driver 32.

The light-emission control signal driver 31 outputs the light-emission control signal pulse in response to the start pulse and the shift clock received from the controller 20 and sequentially shifts the light-emission control signal pulse according to the shift clock. The light-emission control signal driver 31 may be simply referred to as a ‘light-emission driver 31’

Each of the at least one scan driver 32 outputs the scan pulse in response to the start pulse and the shift clock received from the controller 20, and shifts the scan pulse according to a shift clock timing.

The data driver 40 converts the image data RGB into the data voltage Vdata according to the data control signal DCS supplied from the controller 20, and supplies the converted data voltage Vdata to the pixel P through the data line DL.

In FIG. 1, it is illustrated that one data driver 40 is disposed at one side of the display panel 10. However, the number and a position of the data drivers 200 are not limited thereto.

That is, the data driver 40 may be embodied as a plurality of integrated circuits (ICs) which may be disposed at one side of the display panel 10 and may be separately arranged along the one side.

The power supply 50 generates direct current (DC) power necessary for operating a pixel array of the display panel 10 and the display panel driver including the data driver 40 and the gate driver 30, using a DC-DC converter. The DC-DC converter may include a charge pump, a regulator, a buck converter, a boost converter, etc. The power supply 50 receives a DC input voltage applied from the host system (not shown) and generates DC voltages such as the gate on voltage VGL and VEL, the gate off voltage VGH and VEH, the high-potential driving voltage EVDD, the low-potential driving voltage EVSS, etc. The gate on voltage VGL and VEL and the gate off voltage VGH and VEH are supplied to the level shifter (not shown) and the gate driver 30. Each of the high-potential driving voltage EVDD and the low-potential driving voltage EVSS is commonly supplied to the pixels.

FIG. 2 is a diagram showing a pixel circuit of a display device according to one or more example embodiments of the present disclosure.

FIG. 2 only shows an example of a pixel circuit for illustration. A structure of the pixel circuit is not limited particularly as long as the structure thereof may apply a light-emission control signal EM(n) to the pixel to control the light-emission of the light-emitting element EL. For example, the pixel circuit may include a switching thin-film transistor connected to an additional scan signal, and a switching thin-film transistor to which an additional initialization voltage is applied. A connection relationship of the switching element or a connection position of the capacitor may vary. Hereinafter, for convenience of description, a display device with the pixel circuit structure of FIG. 2 is described.

The display panel 10 according to one or more example embodiments of the present disclosure may include the plurality of pixels P.

Referring to FIG. 2, each of the plurality of pixels P according to one or more example embodiments of the present disclosure may include the light-emitting element EL and a driving element DT for driving the light-emitting element EL. The driving element DT may be a driving transistor DT. That is, each of the plurality of pixels P may include a pixel circuit having the driving transistor DT and the light-emitting element EL connected to the pixel circuit.

The display panel 10 according to one or more example embodiments of the present disclosure may include a fifth switching element T5 and a sixth switching element T6. The fifth switching element T5 may perform a switching operation so that an initialization voltage Vini is applied to each of a first electrode of the light-emitting element EL and a gate electrode of the driving element DT. The sixth switching element T6 may perform a switching operation so that a sampling voltage Vsam is applied across a second electrode of the driving element DT and the gate electrode thereof.

The pixel circuit may drive the light-emitting element EL by controlling the driving current flowing through the light-emitting element EL. The pixel circuit may include the driving transistor DT, first to seventh transistors T1 to T7, a sampling capacitor Csam, and a storage capacitor Cstg. Each of the transistors DT, T1 to T7 may include a first electrode, a second electrode, and a gate electrode. One of the first electrode and the second electrode may be a source electrode, and the other of the first electrode and the second electrode may be a drain electrode.

Each of the transistors DT, and T1 to T7 may be a P-type thin-film transistor or an N-type thin-film transistor. In an embodiment of FIG. 2, each of the first transistor T1, the fifth transistor T5, the seventh transistor T7, and the driving transistor DT is embodied as an N-type thin-film transistor, and each of the remaining transistors T2 to T4, and T6 is embodied as a P-type thin-film transistor. However, the present disclosure is not limited thereto, and depending on an embodiment, all or some of the transistors DT, and T1 to T7 may be P-type thin-film transistors or N-type thin-film transistors. Furthermore, the N-type thin-film transistor may be an oxide thin-film transistor (Oxide TFT), and the P-type thin-film transistor may be a low-temperature polycrystalline silicon (LTPS) thin-film transistor.

Hereinafter, an example in which each of the first transistor T1, the fifth transistor T5, the seventh transistor T7, and the driving transistor DT is the N-type thin-film transistor, and each of the remaining transistors T2 to T4 and T6 is the P-type thin-film transistor is described. Therefore, each of the first transistor T1, the fifth transistor T5, the seventh transistor T7, and the driving transistor DT may be turned on based on a high voltage applied thereto, and each of the remaining transistors T2 to T4, and T6 may be turned on based on a low voltage applied thereto.

According to one example, each of the first transistor T1, the third transistor T3, and the fourth transistor T4 constituting the pixel circuit may act as a light-emission control transistor. The second transistor T2 constituting the pixel circuit may act as a data supply transistor. The fifth transistor T5 constituting the pixel circuit may function as an initialization transistor. The sixth transistor T6 constituting the pixel circuit may function as a sampling transistor. The seventh transistor T7 constituting the pixel circuit may function as a compensation transistor.

The light-emitting element EL may include a first electrode and a second electrode. The first electrode of the light-emitting element EL may be an anode electrode 121, and the second electrode of the light-emitting element EL may be a cathode electrode 123. The light-emitting element EL may include the first electrode connected to a fifth node N5, and the second electrode connected to a low driving voltage. That is, the anode electrode 121 of the light-emitting element EL may be connected to the fifth node N5, and the cathode electrode 123 thereof may be connected to a low-potential driving voltage line VSS.

The driving transistor DT may include a first electrode connected to a second node N2, a second electrode connected to a third node N3, and the gate electrode connected to the first node N1. The driving transistor DT may provide a driving current Id to the light-emitting element EL based on a voltage of the first node N1 (or the data voltage stored in the storage capacitor Cstg, which will be described later).

The fifth switching element T5 may be connected to and disposed between the gate electrode N1 of the driving element DT and the first electrode N5 of the light-emitting element EL. The sixth switching element T6 may be connected to the second electrode N3 of the driving element DT.

The fifth switching element T5 may be embodied as a fifth transistor which may be an N-type thin-film transistor. The fifth switching element T5 may include a first electrode receiving the initialization voltage Vini. A second electrode thereof may be connected to the first electrode N5 of the light-emitting element EL. A gate electrode thereof may receive a (n−2)-th light-emission signal EM(n−2).

The fifth transistor T5 may include the first electrode receiving the initialization voltage Vini, the second electrode connected to the fifth node N5, and the gate electrode that receives the (n−2)-th light-emission signal EM(n−2). This fifth transistor T5 may be an initialization transistor.

The fifth transistor T5 may be turned on in response to the (n−2)-th light-emission signal EM(n−2) to initialize the gate electrode N1 of the driving transistor DT using the initialization voltage Vini. Unnecessary charges may remain in the gate electrode N1 of the driving transistor DT due to a high potential driving voltage EVDD stored in the storage capacitor Cstg. Therefore, the initialization voltage Vini may be applied to the gate electrode N1 of the driving transistor DT through the fifth transistor T5, such that the remaining charge amount may be initialized.

Before the light-emitting element EL emits light (or after the light-emitting element EL emits light), the fifth transistor T5 may be turned on in response to the (n−2)-th light-emission signal EM(n−2) to reset the anode electrode (or a pixel electrode) of the light-emitting element EL using the initialization voltage Vini. The light-emitting element EL may have a parasitic capacitor generated between the anode electrode and the cathode electrode. While the light-emitting element EL emits light, the parasitic capacitor may be charged so that the anode electrode of the light-emitting element EL may have a specific voltage. Therefore, the initialization voltage Vini may be applied to the anode electrode of the light-emitting element EL through the sixth transistor T5, such that an amount of charges accumulated in the light-emitting element EL may be initialized.

In accordance with one or more example embodiments of the present disclosure, the fourth and fifth transistors T4 and T5 are configured such that the gate electrodes of the fourth and fifth transistors T4 and T5 commonly receive the (n−2)-th light-emission signal EM(n−2). However, embodiments of the present disclosure are not necessarily limited thereto, and the fourth and fifth transistors T4 and T5 may be configured such that the gate electrodes of the fourth and fifth transistors T4 and T5 receive separate light-emission signals, respectively, and thus the fourth and fifth transistors T4 and T5 are independently controlled.

The sixth switching element T6 may be a sixth transistor which may be a P-type thin-film transistor. A sampling voltage Vsam may be applied to a first electrode of the sixth switching element T6. The second electrode N3 of the driving element DT may be connected to a second electrode of the sixth switching element T6. A gate electrode of the sixth switching element T6 may receive a (n−1)-th second scan signal SC2(n−1).

The sixth transistor T6 may include the first electrode receiving the sampling voltage Vsam, the second electrode connected to the third node N3, and the gate electrode that receives the (n−1)-th second scan signal SC2(n−1). This sixth transistor T6 may be an additional sampling transistor.

The sixth transistor T6 may be turned on in response to the (n−1)-th second scan signal SC2(n−1) to apply the sampling voltage Vsam applied to the first electrode thereof to the second electrode N3 of the driving transistor DT connected to the second electrode thereof. The sixth transistor T6 may apply the sampling voltage Vsam applied to the first electrode thereof, as a bias voltage, to the second electrode N3 of the driving transistor DT.

The seventh switching element T7 and the sampling capacitor Csam may be connected to and disposed between the second electrode N3 and the gate electrode N1 of the driving element DT.

The second electrode N3 of the driving element DT may be connected to a first electrode of the sampling capacitor Csam. A first electrode of the seventh switching element T7 may be connected to a second electrode of the sampling capacitor Csam.

The seventh switching element T7 may be a seventh transistor which may be an N-type thin-film transistor. The gate electrode N1 of the driving element DT and the second electrode of the fifth switching element T5 may be connected to a second electrode of the seventh switching element T7. A fourth node N4 may be connected to a gate electrode of the seventh switching element T7 such that the (n−2)-th light-emission signal EM(n−2) may be applied to the gate electrode thereof.

The seventh transistor T7 may be turned on in response to the (n−2)-th light-emission signal EM(n−2), such that the seventh transistor T7 may be connected in a diode manner to and disposed between the first node N1 and the third node N3. Thus, the threshold voltage Vth of the driving transistor DT may be sampled by the seventh transistor T7. This seventh transistor T7 may be a compensation transistor.

The sampling capacitor Csam may store therein or maintain the sampling voltage Vsam applied thereto through the sixth transistor T6.

The storage capacitor Cstg may be connected to and disposed between the first node N1 and the fifth node N5. That is, the storage capacitor Cstg may be connected to and disposed between the first node N1 as a connection point between the gate electrode of the driving transistor DT and the second electrode of the seventh transistor T7, and the fifth node N5 as a connection point between the second electrode of the fifth transistor T5, and the first electrode of the light-emitting element EL. The storage capacitor Cstg may store therein or maintain the high potential driving voltage EVDD applied thereto.

The first switching element T1 may be connected to and disposed between the gate electrode N1 and the first electrode N2 of the driving element DT. The third switching element T3 may be connected to the first electrode N2 of the driving element DT.

The first switching element T1 may be a first transistor which may be an N-type thin-film transistor. The first transistor T1 may have a first electrode connected to the first electrode N2 of the driving element DT. The gate electrode N1 of the driving element DT may be connected to a second electrode of the first transistor T1. A first scan signal SC1 may be applied to a gate electrode of the first transistor T1.

The third switching element T3 may be a third transistor which may be a P-type thin-film transistor. The high potential driving voltage line VDD may be connected to a first electrode of the third transistor T. The first electrode N2 of the driving element DT may be connected to a second electrode of the third transistor T3. An n-th emission signal EN (n) may be applied to a gate electrode of the third transistor T3.

The fourth switching element T4 may be connected to and disposed between the light-emitting element EL and the driving element DT. The second switching element T2 may be connected to and disposed between the fourth switching element T4 and the driving element DT.

The data voltage Vdata may be applied to a first electrode of the second switching element T2. The second electrode N3 of the driving element DT and the first electrode of the fourth switching element T4 may be connected to a second electrode of the second switching element T. An n-th second scan signal SC2(n) may be applied to a gate electrode of the second switching element T2.

A gate electrode of the fourth switching element T4 may be connected to the gate electrode of the fifth transistor T5 and the gate electrode of the seventh transistor T7 at a fourth node N4. An (n−2)-th light-emission signal EM(n−2) may be applied to the gate electrode of the fourth switching element T4. The first electrode N5 of the light-emitting element EL may be connected to a second electrode of the fourth switching element T4.

The second transistor T2 may include the first electrode connected to the data line DL or receiving the data voltage Vdata, the second electrode connected to the third node N3, and the gate electrode receiving the second scan signal SC2(n). The second transistor T2 may be turned on in response to the second scan signal SC2(n) to transmit the data voltage Vdata to the third node N3. This second transistor T2 may be a data voltage supply transistor.

The first transistor T1, the third transistor T3, and the fourth transistor T4 may be connected to and disposed between the high-potential driving voltage line VDD and the light-emitting element EL, and may constitute a current movement path along which the driving current Id generated from the driving transistor DT travels.

The third transistor T3 may include a first electrode connected to the second node N2 and receiving a high potential driving voltage EVDD through the high potential driving voltage line VDD, a second electrode connected to the second node N2, and a gate electrode that receives the light-emission signal EM(n). The third transistor T3 may be turned on in response to the light-emission signal EM(n) applied to the gate electrode thereof, such that the high-potential driving voltage EVDD applied thereto through the high-potential driving voltage line VDD is applied to the driving transistor DT.

The first transistor T1 may include the first electrode connected to the second node N2 and receiving the high potential driving voltage EVDD through the high potential driving voltage line VDD, the second electrode connected to the first node N1, and the gate electrode that receives the first scan signal SC1. The first transistor T1 may be turned on in response to the first scan signal SC1 to apply the high potential driving voltage EVDD to the gate electrode N1 of the driving transistor DT to turn on the driving transistor DT.

The fourth transistor T4 may include the first electrode connected to the third node N3, the second electrode connected to the fifth node N5 (or the anode electrode of the light-emitting element EL), and the gate electrode that receives the (n−2)-th light-emission signal EM(n−2). The fourth transistor T4 may be turned on in response to the (n−2)-th light-emission signal EM(n−2) applied to the gate electrode thereof, such that the high potential driving voltage EVDD is applied to the light-emitting element EL.

The third and fourth transistors T3 and T4 may be turned on in response to the light-emission signals EM(n) and EM(n−2), respectively, such that the driving current Id may be applied to the light-emitting element EL. Thus, the light-emitting element EL may emit light at a luminance level corresponding to the driving current Id.

The gate driver 30 configured in a GIP (Gate In Panel) manner and the low-potential driving voltage line VSS may be formed to extend along and in an outer area of the display panel 10. The low-potential driving voltage line VSS may be located outwardly of the gate driver 30. Furthermore, the low-potential driving voltage line VSS may be connected to the anode electrode 121 to apply a common voltage thereto. The gate driver 30 is simply shown as a block in a plan view, but may be configured using a thin-film transistor TFT of the same structure as that of each of the thin-film transistors T4 and T6 of the display area AA.

The low-potential driving voltage line VSS may be disposed outwardly of the gate driver 30. The Low-potential driving voltage line VSS may be disposed outwardly of the gate driver 30 so as to surround the display area AA. The low-potential driving voltage line VSS may be made of the same material as that of each of a source/drain electrode of each of the fourth and sixth transistors T4 and T6. However, embodiments of the present disclosure are not limited thereto. For example, the low-potential driving voltage line VSS may be made of the same material as that of a gate electrode 143 and a gate electrode 163 as shown in FIG. 3.

Furthermore, the low-potential driving voltage line VSS may be electrically connected to the anode electrode 121. Alternatively, the low-potential driving voltage line VSS may be electrically connected to the cathode electrode 123. The low-potential driving voltage line VSS may supply the low-potential driving voltage EVSS to the plurality of pixels P in the display area AA.

FIG. 3 is a cross-sectional view showing a stack structure of a display device according to one or more example embodiments of the present disclosure.

Referring to FIG. 3, the display device 100 according to one or more example embodiments of the present disclosure may include a substrate 101, and the driving transistor DT for driving the light-emitting element EL and the forth transistor T4 as the light-emitting transistor which are disposed on the substrate 101.

The driving transistor DT may include a third semiconductor layer 131 and a third gate electrode 133. Furthermore, although not shown in the drawing, the driving transistor DT may include a third source electrode and a third drain electrode.

The fourth transistor T4 may include a fourth semiconductor layer 141 and a fourth gate electrode 143. Furthermore, although not shown in the drawing, the fourth transistor T4 may include a fourth source electrode and a fourth drain electrode.

Furthermore, in the display device 100 according to one or more example embodiments of the present disclosure, the sixth transistor T6 acing as a sampling transistor, and the seventh transistor T7 acing as a compensation transistor may be disposed on the substrate 101.

The sixth transistor T6 may include a sixth semiconductor layer 161 and a sixth gate electrode 163. Furthermore, although not shown in the drawing, the sixth transistor T6 may include a sixth source electrode and a sixth drain electrode.

The seventh transistor T7 may include a seventh semiconductor layer 171 and a seventh gate electrode 123. Furthermore, although not shown in the drawing, the seventh transistor T7 may include a seventh source electrode and a seventh drain electrode.

For convenience of illustration, only the driving transistor DT, the fourth transistor T4, the sixth transistor T6, and the seventh transistor T6 among the various thin-film transistors that may be included in the display device 100 are shown. However, other thin-film transistors such as switching transistors may also be included in the display device 100. Furthermore, in the present disclosure, an example in which the thin-film transistor TFT has a coplanar structure is described. However, the thin-film transistor TFT may be implemented to have other structures such as a staggered structure. The present disclosure is not limited thereto.

The display device 100 according to one or more example embodiments of the present disclosure may include a first buffer layer 102 disposed on a substrate 101, and the fourth semiconductor layer 141 of the fourth transistor T4 and the sixth semiconductor layer 161 of the sixth transistor T6 disposed on the first buffer layer 102.

In this regard, the substrate 101 may include a first polyimide layer PI1, an interlayer IL on the first polyimide layer PI1, and a second polyimide layer PI2 on the intermediate layer.

The first buffer layer 102 may delay the diffusion of moisture and/or oxygen that has penetrated the substrate 101. The first buffer layer 102 may include a multi-buffer layer M-BUF and an active buffer layer A-BUF on the multi-buffer layer M-BUF.

Furthermore, the display device 100 may include a first insulating layer 103 disposed on the first buffer layer 102, the fourth semiconductor layer 141, and the sixth semiconductor layer 161, and the fourth gate electrode 143 and the sixth gate electrode 163 disposed on the first insulating layer 103. The first insulating layer 103 protects the fourth semiconductor layer 141 and the sixth semiconductor layer 161 and may block various types of defects flowing from the substrate 101. The first insulating layer 103 may include a gate insulation layer GI.

The uppermost layer 102b of the first buffer layer 102 in contact with the first insulating layer 103 may be made of a material that has different etching characteristics from etching characteristics of each of the remaining layer 102a of the first buffer layer 102, the first insulating layer 103, a second insulating layer 104, a second buffer layer 105, a third insulating layer 106, and a first interlayer insulating layer 107. The uppermost layer 102b of the first buffer layer 102 in contact with the first insulating layer 103 may be made of one of silicon nitride (SiNx) and silicon oxide (SiOx). Each of the remaining layers 102a of the first buffer layer 102, the first insulating layer 103, the second insulating layer 104, the second buffer layer 105, the third insulating layer 106, and the first interlayer insulating layer 107 may be made of the other of silicon nitride (SiNx) and silicon oxide (SiOx). For example, the uppermost layer 102b of the first buffer layer 102 in contact with the first insulating layer 103 may be made of silicon nitride (SiNx), while each of the remaining layers 102a of the first buffer layer 102, the first insulating layer 103, the second insulating layer 104, the second buffer layer 105, the third insulating layer 106, and the first interlayer insulating layer 107 may be made of silicon oxide (SiOx). However, embodiments of the present disclosure are not limited thereto.

The fourth transistor T4 may receive the high potential driving voltage EVDD in response to the (n−2)-th light-emission signal EM(n−2) supplied to the fourth gate electrode 143 to control the current supplied to the light-emitting element EL to control the amount of light emitted from the light-emitting element EL, and to supply a constant current to the light-emitting element EL based on the voltage charged in the storage capacitor Cstg to maintain light emission of the light-emitting element EL until a data signal of a next frame is supplied thereto.

The sixth transistor T6 may receive the sampling voltage signal Vsam in response to the (n−1)-th second scan signal SC2(n−1) supplied to the sixth gate electrode 163 and deliver the sampling voltage signal Vsam to the second electrode N3 of the driving transistor DT, such that the sampling voltage signal Vsam may be charged in the sampling capacitor Csam.

As shown in FIG. 3, the fourth transistor T4 may include the fourth semiconductor layer 141 disposed on the first insulating layer 103, the fourth gate electrode 143 that overlaps the fourth semiconductor layer 141 while the first insulating layer 103 is disposed therebetween, and a second electrode which is disposed on the second interlayer insulating layer 108 and which is in contact with the fourth semiconductor layer 141. The second electrode may be formed integrally with a first connection electrode connected to the first electrode 121 of the light-emitting element EL. Although not shown in FIG. 3, the fourth transistor T4 may have a first electrode formed on the second interlayer insulating layer 108, and spaced apart from the second electrode, wherein the first electrode is in contact with the fourth semiconductor layer 141. When the first electrode of the fourth transistor T4 is a source electrode, the second electrode thereof may be a drain electrode. Conversely, when the first electrode thereof is a drain electrode, the second electrode thereof may be a source electrode. The fourth transistor T4 may include a P-type (P-MOSFET) thin-film transistor TFT and a low temperature polycrystalline silicon (LTPS) thin-film transistor TFT.

As shown in FIG. 3, the sixth transistor T6 may include the sixth semiconductor layer 161 disposed on the first insulating layer 103, the sixth gate electrode 163 that overlaps the sixth semiconductor layer 161 while the first insulating layer 103 is disposed therebetween, and a second electrode that is disposed on the second interlayer insulating layer 108 and is in contact with the sixth semiconductor layer 161. The second electrode may be formed integrally with a second connection electrode connected to the second electrode N3 of the driving transistor DT and the first electrode 151 of the sampling capacitor Csam. Although not shown in FIG. 3, the sixth transistor T6 may have a first electrode which is formed on the second interlayer insulating layer 108, and is spaced apart from the second electrode, and is in contact with the sixth semiconductor layer 161. When the first electrode of the sixth transistor T6 is a source electrode, the second electrode thereof may be a drain electrode. Conversely, when the first electrode thereof is a drain electrode, the second electrode thereof may be a source electrode. The sixth transistor T6 may include a P-type (P-MOSFET) thin-film transistor TFT and a low temperature polycrystalline silicon (LTPS) thin-film transistor TFT.

Each of the fourth semiconductor layer 141 and the sixth semiconductor layer 161 may be an area where a channel is generated when the thin-film transistor TFT operates. Each of the fourth semiconductor layer 141 and the sixth semiconductor layer 161 may be made of an oxide semiconductor, amorphous silicon (a-Si), polycrystalline silicon (poly-Si), or various organic semiconductors such as pentacene, etc. However, embodiments of the present disclosure are not limited thereto.

The fourth semiconductor layer 141 and the sixth semiconductor layer 161 may be formed on the first insulating layer 103. Each of the fourth semiconductor layer 141 and the sixth semiconductor layer 161 may include a channel area, a source area, and a drain area. The channel area of the fourth semiconductor layer 141 may overlap the fourth gate electrode 143 while the first insulating layer 103 is disposed therebetween, thereby forming a channel area between the source and drain electrodes. The channel area of the sixth semiconductor layer 161 may overlap the sixth gate electrode 163 while the first insulating layer 103 is disposed therebetween, thereby forming a channel area between the source and drain electrodes. The source area may be electrically connected to the source electrode via a contact hole extending through the first insulating layer 103, the second insulating layer 104, the second buffer layer 105, the third insulating layer 106, the first interlayer insulating layer 107, and the second interlayer insulating layer 108. The drain area may be electrically connected to the drain electrode via a contact hole extending through the first insulating layer 103, the second insulating layer 104, the second buffer layer 105, the third insulating layer 106, the first interlayer insulating layer 107, and the second interlayer insulating layer 108. The first buffer layer 102 may be disposed between the fourth semiconductor layer 141 and the sixth semiconductor layer 161 and the substrate 101.

The fourth gate electrode 143 and the sixth gate electrode 163 may be formed on the first insulating layer 103. The fourth gate electrode 143 and the sixth gate electrode 163 may overlap the channel area of the fourth semiconductor layer 141 and the channel area of the sixth semiconductor layer 161, respectively while the first insulating layer 103 is interposed therebetween. Each of the fourth gate electrode 143 and the sixth gate electrode 163 may be made of a first conductive material and may be embodied as a single layer or multi-layers made of magnesium (Mg), molybdenum (Mo), aluminum (Al), chromium (Cr), gold (Au), titanium (Ti), nickel (Ni), neodymium (Nd), copper (Cu), or an alloy thereof. However, embodiments of the present disclosure are not limited thereto.

The source electrode of each of the fourth transistor T4 and the sixth transistor T6 may be connected to an exposed source area of each of the fourth semiconductor layer 141 and the sixth semiconductor layer 161 via each contact hole extending through the first insulating layer 103, the second insulating layer 104, the second buffer layer 105, the third insulating layer 106, the first insulating layer 106, the interlayer insulating layer 107 and the second interlayer insulating layer 108. The drain electrode of each of the fourth transistor T4 and the sixth transistor T6 may face the source electrode thereof and may be connected to the drain area of each of the fourth semiconductor layer 141 and the sixth semiconductor layer 161 via each contact hole extending through the first insulating layer 103, the second insulating layer 104, the second buffer layer 105, and the third insulating layer 106, the first interlayer insulating layer 107 and the second interlayer insulating layer 108. Each of these source and drain electrodes may be made of a second conductive material and may be embodied as a single layer or multi-layers made of molybdenum (Mo), aluminum (Al), chromium (Cr), gold (Au), titanium (Ti), nickel (Ni), neodymium (Nd), copper (Cu), or an alloy thereof. However, embodiments of the present disclosure are not limited thereto.

The display device 100 according to one or more example embodiments of the present disclosure may include the second insulating layer 104 disposed on the first insulating layer 103, the fourth gate electrode 143, and the sixth gate electrode 163, and the second buffer layer 105 disposed on the second insulating layer 104.

The second insulating layer 104 may include a gate insulating layer GI, and the second buffer layer 105 may include an oxide buffer layer O-BUF.

Furthermore, the display device 100 may include the seventh semiconductor layer 171 of the seventh transistor T7 and the third semiconductor layer 131 of the driving transistor DT disposed on the second buffer layer 105, and the third insulating layer 106 disposed on the buffer layer 105, the third semiconductor layer 131, and the seventh semiconductor layer 171.

Furthermore, in the display device 100, the third gate electrode 133 overlapping the third semiconductor layer 131 of the driving transistor DT may be disposed on the third insulating layer 106. The seventh gate electrode 123 overlapping the seventh semiconductor layer 171 of the seventh transistor T7 may be disposed on the third insulating layer 106.

Furthermore, the display device 100 may have the first electrode 151 of the sampling capacitor Csam disposed on a portion of the third insulating layer 106 disposed between the third gate electrode 133 and the seventh gate electrode 123.

Each of the driving transistor DT and the seventh transistor T7 may include an N-type (N-MOSFET) thin-film transistor TFT and an oxide thin-film transistor TFT.

Furthermore, the display device 100 may include the first interlayer insulating layer 107 disposed on the third gate electrode 133, the seventh gate electrode 123, and the first electrode 151 of the sampling capacitor Csam, and the second electrode 153 of the sampling capacitor Csam disposed on the first interlayer insulating layer 107.

The first interlayer insulating layer 107 may include a first oxide interlayer insulating film ILD1. The second electrode 153 of the sampling capacitor Csam may be disposed on the first interlayer insulating layer 107 so as to overlap the first electrode 151 of the sampling capacitor Csam.

Furthermore, the display device 100 may include the second interlayer insulating layer 108 disposed on the second electrode 153 of the sampling capacitor Csam and the first interlayer insulating layer 107. The first connection electrode, the second connection electrode, and a third connection electrode may be disposed on the second interlayer insulating layer 108. The second interlayer insulating layer 108 may include a second oxide interlayer insulating film ILD2.

One end of the second connection electrode may be electrically connected to an exposed portion of the second electrode of the driving transistor DT via a contact hole extending through the second interlayer insulating layer 108, the first interlayer insulating layer 107, and the third insulating layer 106.

Another end of the second connection electrode may be electrically connected to an exposed portion of the second electrode of the sixth transistor T6 via a contact hole extending through the second interlayer insulating layer 108, the first interlayer insulating layer 107, the third insulating layer 106, the second buffer layer 105, the second insulating layer 104, and the first insulating layer 103.

Still another end of the second connection electrode may be electrically connected to the first electrode 151 of the sampling capacitor Csam via a contact hole extending through the second interlayer insulating layer 108 and the first interlayer insulating layer 107.

One end of the third connection electrode may be electrically connected to the second electrode 153 of the sampling capacitor Csam via a contact hole extending through the second interlayer insulating layer 108.

The other end of the third connection electrode may be electrically connected to an exposed portion of the first electrode of the seventh transistor T7 via a contact hole extending through the second interlayer insulating layer 108, the first interlayer insulating layer 107, and the third insulating layer 106.

Furthermore, the display device 100 may include a first planarization layer (PLN1) 109 disposed on the second interlayer insulating layer 108, the first connection electrode, the second connection electrode, and the third connection electrode. A fourth connection electrode 184 may be disposed on the first planarization layer 109.

The fourth connection electrode 184 has one end electrically connected to the second electrode of the fourth transistor T4 via a contact hole extending through the first planarization layer 109, and the other end electrically connected to the second electrode of the driving transistor DT via a contact hole extending through the planarization layer 109. The fourth connection electrode 184 may be made of a material with low specific resistance. However, embodiments of the present disclosure are not limited thereto.

Furthermore, the display device 100 may have a second planarization layer (PLN2) 110 disposed on the first planarization layer 109 and the fourth connection electrode 184. The first electrode 121 of the light-emitting element EL may be disposed on the second planarization layer 110. The first electrode 121 of the light-emitting element EL may be an anode electrode.

Furthermore, in the display device 100, a light-emitting layer 122 may be disposed on the first electrode 121 of the light-emitting element EL. The second electrode 123 may be disposed on the light-emitting layer 122 of the light-emitting element EL. That is, a bank layer 111 and the light-emitting layer 122 may be disposed on the second planarization layer 110 and the first electrode 121 of the light-emitting element EL. The second electrode 123 of the light-emitting element EL may be disposed on the light-emitting layer 122 and the bank layer 111.

The light-emitting layer 122 may constitute an organic light-emitting diode (OLED). In the light-emitting element EL, the first electrode 121 may be an anode electrode, and the second electrode 123 may be a cathode electrode.

The light-emitting layer 122 may include at least one of a red light-emitting layer 122R that emits red light, a green light-emitting layer 122G that emits green light, and a blue light-emitting layer 122B that emits blue light.

The anode electrode 121 of each pixel is not covered with the bank layer 111 so as to be exposed. The bank layer 111 may be made of an opaque material (e.g., black) to prevent light interference between adjacent pixels. In this case, the bank layer 111 may include a light-shielding material including at least one of color pigment, organic black, and carbon black. The present disclosure is not limited thereto.

Referring to FIG. 3, the at least one light-emitting layer 122 may be formed on a portion of the anode electrode 121 corresponding to a light-emitting area defined by the bank layer 111. The at least one light-emitting layer 122 may include a hole transport layer, a hole injection layer, a hole blocking layer, a light-emitting layer, an electron injection layer, an electron blocking layer, and an electron transport layer on the anode electrode 121. A stacking order of the hole transport layer, the hole injection layer, the hole blocking layer, the light-emitting layer, the electron injection layer, the electron blocking layer, and the electron transport layer may be based on a light-emitting direction. In addition, the light-emitting layer 122 may include first and second light-emitting stacks facing each other while a charge generating layer is interposed therebetween. In this case, the light-emitting layer 122 of one of the first and second light-emitting stacks may generate blue light, while the light-emitting layer 122 of the other of the first and second light-emitting stacks may generate yellow-green light, so that white light may be generated from a combination of the first and second light-emitting stacks. The white light generated from the combination of the first and second light-emitting stacks may be incident on a color filter positioned above or below the light-emitting layer 122, such that a color image may be realized. In another example, each light-emitting layer 122 may generate each color light corresponding to each pixel without a separate color filter such that a color image may be rendered. For example, the light-emitting layer 122 of a red (R) pixel emits red light, the light-emitting layer 122 of a green (G) pixel emits green light, and the light-emitting layer 122 of a blue (B) pixel emits blue light.

Referring to FIG. 3, the cathode electrode 123 as the second electrode of the light-emitting element EL may be formed to face the anode electrode 121 while the light-emitting layer 122 is disposed therebetween, and may receive the high-potential driving voltage EVDD.

Although not shown in FIG. 3, an encapsulation layer may be disposed on the second electrode 123 of the light-emitting element EL. The encapsulation layer may prevent external moisture or oxygen from penetrating into the light-emitting element EL that is vulnerable to external moisture or oxygen. For this purpose, the encapsulation layer may include at least one inorganic encapsulation layer and at least one organic encapsulation layer. However, embodiments of the present disclosure are not limited thereto.

In an embodiment of the present disclosure, the encapsulation layer may have a stack structure in which a first encapsulation layer is disposed on the cathode electrode 123, a second encapsulation layer is disposed on the first encapsulation layer, and a third encapsulation layer is disposed on the second encapsulation layer.

The first encapsulation layer is formed on the substrate 101 on which the cathode electrode 123 has been formed. The third encapsulation layer is formed on the substrate 101 on which the second encapsulation layer has been formed. The third encapsulation layer and the first encapsulation layer may surround a top face, a bottom face and a side face of the second encapsulation layer. The first encapsulation layer and the third encapsulation layer may minimize or prevent penetration of external moisture or oxygen into the light-emitting element EL. Each of the first encapsulation layer and the third encapsulation layer may be made of an inorganic insulating material that may be deposited at a low temperature, such as silicon nitride (SiNx), silicon oxide (SiOx), silicon oxynitride (SiON), or aluminum oxide (Al₂O₃). Each of the first encapsulation layer and the third encapsulation layer is deposited in a low temperature atmosphere. Thus, during a deposition process of the first encapsulation layer and the third encapsulation layer, the light-emitting element EL which is vulnerable to a high-temperature atmosphere may be prevented from being damaged.

The second encapsulation layer serves as a shock-absorbing layer to relieve a stress between layers due to bending of the display device 100, and may planarize a step between layers. The second encapsulation layer may be made of a non-photosensitive organic insulating material such as acryl resin, epoxy resin, phenolic resin, polyamide resin, polyimide resin, polyethylene or silicon oxycarbon (SiOC) or a photosensitive organic insulating material such as photoacryl. The present disclosure is not limited thereto. When the second encapsulation layer is formed using an inkjet method, a dam may be disposed to prevent the second encapsulation layer in a liquid state from spreading to an edge of the substrate 101. The dam may be closer to the edge of the substrate 101 than the second encapsulation layer may be. The dam may prevent the second encapsulation layer in the liquid state from spreading to a pad area where a conductive pad disposed at the outermost side of the substrate 101 is disposed.

The dam is designed to prevent diffusion of the second encapsulation layer. However, when the second encapsulation layer overflows the dam during a process, the second encapsulation layer as an organic layer may be exposed to an outside, so that moisture or the like may invade the light-emitting element. Therefore, to prevent the invasion, at least ten dams may be stacked.

In one example, a touch layer may be disposed on the encapsulation layer. In the touch layer, a touch buffer film may be positioned between a touch sensor metal including touch electrode connection lines and touch electrodes and the cathode electrode 123 of the light-emitting element EL.

The touch buffer film may prevent chemical (developer, etchant, etc.) used in a manufacturing process of the touch sensor metal disposed on the touch buffer film or moisture from the outside from invading the light-emitting layer 122 including an organic material. Accordingly, the touch buffer layer may prevent damage to the light-emitting layer 122 as vulnerable to the chemicals or moisture.

The touch buffer film may be made of an organic insulating material that can be formed at a low temperature below or equal to a certain temperature (100 degrees Celsius) to prevent damage to the light-emitting layer 122 including the organic material vulnerable to a high temperature, and that has a low dielectric constant of 1 to 3. For example, the touch buffer layer may be made of an acryl-based, epoxy-based, or siloxane-based material. The touch buffer film made of the organic insulating material and having planarization performance may prevent damage to the encapsulation layer and fracture of the touch sensor metal formed on the touch buffer film due to bending of the organic light-emitting display device.

According to a mutual-capacitance-based touch sensor structure, the touch electrodes and may be disposed on the touch buffer layer, and the touch electrodes and may be disposed to intersect each other. The touch electrode connection lines and may electrically connect the touch electrodes and to each other. The touch electrode connection lines and the touch electrodes and may be positioned on different layers while the touch insulating film is interposed therebetween. The touch electrode connection lines and may overlap the bank layer, thereby preventing an aperture ratio from being lowered.

In one example, a portion of the touch electrode connection line may extend along upper and side surfaces of the encapsulation layer and upper and side surfaces of the dam and then may be electrically connected to a touch driver circuit (not shown) through a pad. Thus, the touch electrodes and may be electrically connected to the touch driver circuit. The portion of the touch electrode connection line may receive a touch driving signal from the touch driver circuit and transmit the same to the touch electrodes and, and may receive a touch sensing signal from the touch electrodes and may transmit the same to the touch driver circuit.

A touch protective film may be disposed on the touch electrode. The touch protective film may be disposed only on the touch electrode. However, embodiments of the present disclosure are not limited thereto. The touch protective film may extend to an inner end or an outer end of the dam and thus may also be disposed on the touch electrode connection line.

Further, a color filter (not shown) may be further disposed on the encapsulation layer, and the color filter may be positioned on the touch layer or between the encapsulation layer and the touch layer.

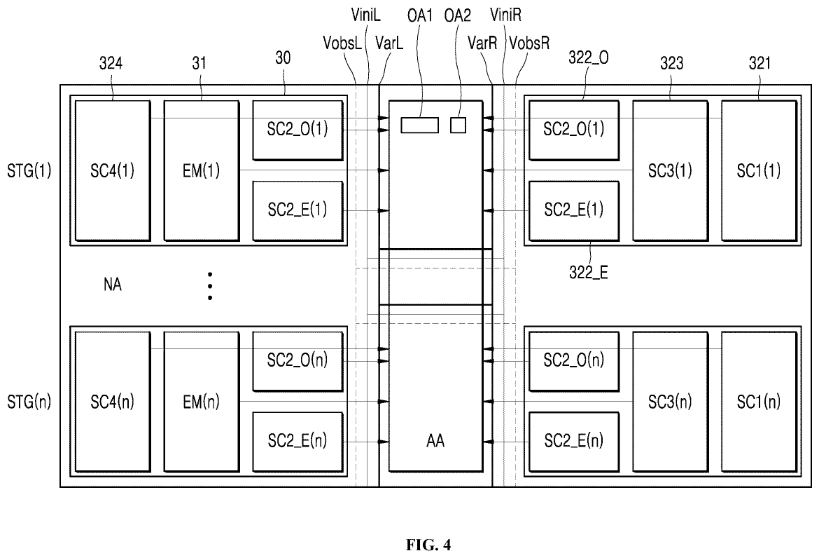

FIG. 4 is a diagram of a configuration of a gate driver in a display device according to one or more example embodiments of the present disclosure.

Referring to FIG. 4, the gate driver 30 according to one or more example embodiments of the present disclosure may include the light-emission driver 31 and the scan driver 32.

The scan driver 32 may include a first scan driver to a fourth scan driver 321, 322, 323, and 324. Further, the second scan driver 322 may be composed of an odd-numbered second scan driver 322_O and an even-numbered second scan driver 322_E.

The gate driver 30 may include shift registers which may be respectively disposed on both opposing sides of the display area AA symmetrically. Further, in the gate driver 30, the shift register on one side of the display area AA may be configured to include the second scan drivers 322_O and 322_E, the fourth scan driver 324 and the light-emission control signal driver 31. The shift register on the other side of the display area AA may be configured to include the first scan driver 321, the second scan drivers 322_O and 322_E, and the third scan driver 323. However, the present disclosure is not limited thereto, and the light-emission control signal driver 31 and the first to fourth scan drivers 321, 322, 323, and 324 may be arranged in a manner varying according to embodiments.

Each of stages STG(1) to STG(n) of the shift register may include each of first scan signal generators SC1(1) to SC1(n), each of second scan signal generators SC2_O(1) to SC2_O(n) and SC2_E(1) to SC2_E(n), each of third scan signal generators SC3(1) to SC3(n), each of fourth scan signal generators SC4(1) to SC4(n) and each of light-emission control signal generators EM(1) to EM(n).

The first scan signal generators SC1(n) to SC1(n) respectively output first scan signals SC1(n) to SC1(n) through a first scan line SCL1 of the display panel 10. The second scan signal generators SC2(1) to SC2(n) respectively output second scan signals SC2(1) to SC2(n) through a second scan line SCL2 of the display panel 10. The third scan signal generators SC3(1) to SC3(n) respectively output third scan signals SC3(1) to SC3(n) through a third scan line SCL3 of display panel 10. The fourth scan signal generators SC4(1) to SC4(n) respectively output fourth scan signals SC4(1) to SC4(n) through fourth scan line SCL4 of the display panel 10. The light-emission control signal generators EM(1) to EM(n) respectively output light-emission control signals EM(1) to EM(n) through a light-emission control line EML of the display panel 10.

The first scan signals SC1(n) to SC1(n) may be used as signals for operating an A-th transistor included in the pixel circuit such as a compensation transistor. The second scan signals SC2(1) to SC2(n) may be used as signals for operating a B-th transistor included in the pixel circuit, such as a data supply transistor. The third scan signals SC3(1) to SC3(n) may be used as signals for operating a C-th transistor included in the pixel circuit, such as a bias transistor. The fourth scan signals SC4(1) to SC4(n) may be used as signals for operating a D-th transistor included in the pixel circuit, such as an initialization transistor. The light-emission control signals EM(1) to EM(n) may be used as signals for operating an E-th transistor included in the pixel circuit, such as a light-emission control transistor. For example, when light-emission control transistors of pixels are controlled using the light-emission control signals EM(1) to EM(n), an emission time of the light-emitting element EL is varied.

Embodiments of the present disclosure are not limited thereto. For example, the first scan signals SC1(1) to SC1(n) may be used as signals to drive the light-emission control transistor (e.g., T1) included in the pixel circuit. Furthermore, the light-emission signals EM(n) and EM(n-2) may be used as signals to drive the light-emission control transistors (e.g., T3 and T4) included in the pixel circuit. Furthermore, the second scan signals SC2(n), and SC2(n−1) may be used as signals to drive the data supply transistor (e.g., T2) or the sampling transistor (e.g., T6) included in the pixel circuit.

Referring to FIG. 4, bias voltage bus lines VobsL and VobsR, first initialization voltage bus lines VarL and VarR, and second initialization voltage bus lines ViniL and ViniR may be disposed between the gate driver 30 and the display area AA.

The bias voltage bus lines VobsL and VobsR, the first initialization voltage bus lines VarL and VarR, and the second initialization voltage bus lines ViniL and ViniR may supply respectively a bias voltage Vobs, a first initialization voltage Var, and a second initialization voltage Vini from the power supply 50 to the pixel circuit.

In the drawing, it is shown that the bias voltage bus lines VobsL and VobsR are located on the left and right sides of the display area AA, respectively, the first initialization voltage bus lines VarL and VarR are located on the left and right sides of the display area AA, respectively, and the second initialization voltage bus lines ViniL and ViniR are located on the left and right sides of the display area AA, respectively. However, embodiments of the present disclosure are limited thereto. Each of the bias voltage bus line, the first initialization voltage bus line, and the second initialization voltage bus line may be located only on the left side or only on the right side of the display area AA. That is, the position of each of the bias voltage bus line, the first initialization voltage bus line, and the second initialization voltage bus line does not limit the display device of the present disclosure.

Referring to FIG. 4, at least one optical area OA1 and OA2 may be disposed in the display area AA.

The at least one optical area OA1 and OA2 may be positioned so as to overlap at least one optical and electronic device, such as a capturing device such as a camera (an image sensor), and a detection sensor such as a proximity sensor and a luminance sensor.

For operation of the optical electronic device, the at least one optical area OA1 and OA2 may have a light transmissive structure and thus may have a transmittance equal to or greater than a predefined value. In other words, the number of pixels P per unit area in at least one optical area OA1 and OA2 may be smaller than the number of pixels P per unit area in a general area of the display area AA except for the at least one optical area OA1 and OA2. That is, a resolution of at least one optical area OA1 and OA2 may be lower than that of the general area of the display area AA.

The light transmissive structure of the at least one optical area OA1 and OA2 may be formed by patterning a cathode electrode in an area where the pixel P is not disposed. At this time, a portion of the cathode electrode to be patterned may be removed using a laser. Alternatively, the cathode electrode may be selectively formed so as to be patterned using a material such as a cathode deposition prevention layer.

Alternatively, the light transmissive structure of the at least one optical area OA1 and OA2 may be formed by forming the light-emitting element EL and the pixel circuit in a separated manner in the pixel P. In other words, the light-emitting element EL of the pixel P may be positioned on the at least one optical area OA1 and OA2, while a plurality of transistors TFT constituting the pixel circuit may be disposed around the at least one optical area OA1 and OA2, and the light-emitting element EL and the pixel circuit may be electrically connected to each other via a transparent metal layer.

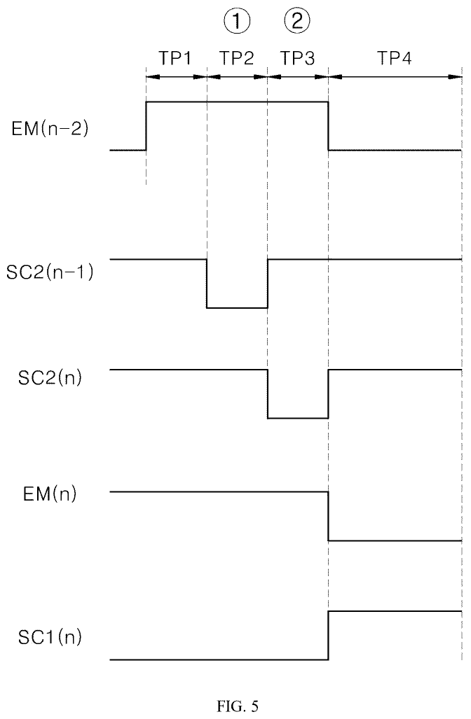

FIG. 5 is a diagram for illustrating application of a scan signal and a light-emission signal in a pixel circuit according to one or more example embodiments of the present disclosure.

For example, FIG. 5 is a diagram for illustrating application of the scan signal and the light-emission signal during a refresh period of the pixel circuit as shown in FIG. 2.

A display device 100 according to one or more example embodiments of the present disclosure may operate as a VRR (variable refresh rate) mode display device. In the VRR mode, the display device operates at a constant frequency. When a high-speed operation is required, a refresh rate at which the data voltage Vdata is updated increases. Thus, the pixel operates at the increased refresh rate. When low power consumption or a low-speed operation is required, the refresh rate is lowered such that the pixel operates at the lowered refresh rate.

Each of the plurality of pixels P may operate based on a combination of a refresh period and a hold period within 1 second. In the present disclosure, one set is defined as a combination of a refresh period in which the data voltage Vdata is updated and a hold period in which the data voltage Vdata is not updated for 1 second. The combination of the refresh period and the hold period is repeated on a one set period basis. A set period may be a predetermined period.

When the device operates at a refresh rate of 120 Hz, only the refresh period may be repeated. That is, the refresh period may be repeated 120 times within 1 second. One refresh period is 1/120=8.33 ms, and one set period is also 8.33 ms.

When the refresh rate is 60 Hz, the refresh period and the hold period may be repeated alternately with each other. That is, the refresh period and the hold period may be alternately repeated with each other, such that each of the refresh period and the hold period may be repeated 60 times within 1 second. Thus, each of one refresh period and one hold period is 0.5/60=8.33 ms, and one set period is 16.66 ms.

When the refresh rate is 1 Hz, one frame may be composed of one refresh period, and 119 hold periods subsequent to the one refresh period. Furthermore, when the refresh rate is 1 Hz, one frame may be composed of a plurality of refresh periods and a plurality of hold periods. In this regard, a period of each of one refresh period and one hold period is 1/120=8.33 ms, and one set period is 1s.

In the refresh period, a new data voltage Vdata is charged to apply the new data voltage Vdata to the driving transistor DT. In the hold period, the data voltage Vdata of a previous frame is maintained. In this regard, the hold period may be referred to as a skip period in the sense that a process of applying the new data voltage Vdata to the driving transistor DT is omitted in the hold period.

Each of the plurality of pixels P may initialize the charged or remaining voltage within the pixel circuit during the refresh period. Specifically, each of the plurality of pixels P may remove the influence of the data voltage Vdata and the high potential driving voltage EVDD stored in a previous frame Frame during the refresh period. Accordingly, each of the plurality of pixels P may display an image corresponding to the new data voltage Vdata in the hold period.

During the hold period, each of the plurality of pixels P may provide the driving current corresponding to the data voltage Vdata to the light-emitting element EL to display an image and may maintain a turned-on state of the light-emitting element EL.

First, with referring to FIG. 5, the operation of the pixel circuit and the light-emitting element is described during the refresh period.

The refresh period may be composed of a first period TP1, a second period TP2, a third period TP3, and a fourth period TP4. However, this is only an example, and the present disclosure is not necessarily limited to this order.

The display device 100 according to one or more example embodiments of the present disclosure may include the display panel 10, the light-emission driver 31, the scan driver 32, and the data driver 40, and the controller 20.

The display panel 10 may include the light-emitting element EL, the driving element DT for driving the light-emitting element EL, the fifth switching element T5 configured to be switched so that the initialization voltage Vini is applied to each of the first electrode 121 of the light-emitting element EL, and the gate electrode N1 of the driving element DT, and the sixth switching element T6 configured to be switched to apply the sampling voltage Vsam across the second electrode N3 and the gate electrode N1 of the driving element DT.

The light-emission driver 31 supplies the (n−2)-th light-emission signal EM(n−2) to the fifth switching element T5.

The scan driver 32 supplies the (n−1)-th second scan signal SC2(n−1) to the sixth switching element T6.

The data driver 40 supplies the data voltage Vdata between the light-emitting element EL and the driving element DT.

For this purpose, the controller 20 controls the light-emission driver 31, the scan driver 32, and the data driver 40.

Referring to FIG. 5, the pixel circuit may operate in the first period TP1 during the refresh period. The first period TP1 may be referred to as an initialization period.

In the first period TP1, the light-emission driver 31 applies a high-level (n−2)-th light-emission signal EM(n−2) to the fifth switching element T5 to turn on the fifth switching element T5.

Each of the (n−2)-th light-emission signal EM(n−2) and the (n−1)-th second scan signal SC2(n−1), the n-th second scan signal SC2(n), the n-th light-emission signal EM(n) is a high level voltage, and the n-th first scan signal SC1(n) is a low level voltage.

Accordingly, the fifth switching element T5 and the seventh switching element T7 are turned on, while the first to fourth switching elements T1 to fourth switching elements T4 and the sixth switching element T6 are turned off.

When the fifth switching element T5 has been (or is) turned on, the initialization voltage Vini is applied to the light-emitting element EL and the driving element DT, such that the first electrode N5 of the light-emitting element EL and the gate electrode N1 of the driving element DT are initialized.

As the fifth and seventh switching elements T5 and T7 are turned on, the gate electrode N1 and the second electrode N3 of the driving transistor DT connected to the first node N1 are initialized with the initialization voltage Vini.

Next, in the second period TP2, the scan driver 32 applies the (n−1)-th second scan signal SC2(n−1) to the sixth switching element T6 to turn on the sixth switching element T6.

In this regard, each of the (n−1)-th second scan signal SC2(n−1) and the n-th first scan signal SC1n is a low level voltage, while each of the (n−2)-th light-emission signal EM(n−2), the n-th second scan signal SC2(n), and the n-th light-emission signal EM(n) is a high level voltage.

Accordingly, the fifth switching element T5, the sixth switching element T6, and the seventh switching element T7 are turned on, while the first switching element T1 to the fourth switching elements T4 are turned off.

When the sixth switching element T6 has been (or is) turned on, the sampling voltage Vsam is applied to the second electrode N3 of the driving element DT.

The sampling capacitor Csam and the seventh switching element T7 are connected to the second electrode N3 of the driving element DT. The seventh switching element T7 is connected to the gate electrode N1 of the driving element DT.

As the seventh switching element T7 and the sampling capacitor Csam are connected to and disposed between the second electrode N3 of the driving element DT and the gate electrode N1 of the driving element DT, the sampling voltage Vsam may be charged in the sampling capacitor Csam connected to the second electrode N3 of the driving element DT.

Therefore, the gate node N1 of the driving element DT may be sampled based on a voltage Vth+Vsam obtained by adding the sampling voltage Vsam to the threshold voltage Vth.

In FIG. 5, the second period TP2 may include a bias period. The bias period refers to a period for which an on-bias stress OBS operation in which the bias voltage Vobs is applied is performed.

As the sixth switching element T6 has been (or is) turned on, the sampling voltage Vsam is applied, as the bias voltage Vobs, to the second electrode N3 of the driving transistor DT.

In this regard, the bias voltage Vobs is supplied to the third node N3 as the drain electrode of the driving transistor DT. Thus, in the light-emission period, a charging time or charging delay of the voltage of the fifth node N5 as the anode electrode of the light-emitting element EL may be reduced. The driving transistor DT is maintained at a stronger saturation state.

For example, as the bias voltage Vobs increases, the voltage of the third node N3 as the drain electrode of the driving transistor DT may increase, and a gate-source voltage or a drain-source voltage of the driving transistor DT may decrease. Therefore, it is desirable that the bias voltage Vobs is greater than the data voltage Vdata.

In this regard, a magnitude of the drain-source current Id flowing through the driving transistor DT may be reduced, and a stress of the driving transistor DT may be reduced in a positive bias stress situation, thereby resolving the charging delay of the voltage of the third node N3. In other words, a hysteresis of the driving transistor DT may be alleviated by performing an on-bias stress (OBS) operation thereon before sampling the threshold voltage Vth of the driving transistor DT.

Accordingly, in the at least one second period TP2, the on-bias stress (OBS) operation may be defined as an operation of directly applying an appropriate bias voltage to the driving transistor DT during non-emission periods.

The second switching element T2 may be connected to the second electrode N3 of the driving element DT.

In the third period TP3, the scan driver 32 may turn on the second switching element T2 by applying the n-th second scan signal SC2(n) to the second switching element T2.

In this regard, each of the n-th first scan signal SC1(n) and the n-th second scan signal SC2(n) is a low level voltage, and each of remaining signals is a high level voltage.

Accordingly, the second switching element T2 and the seventh switching element T7 are turned on, while the first switching element T1, the third switching element T3, the fourth switching element T4, and the sixth switching element T6 are turned off.

In the third period TP3, when the second switching element T2 has been (or is) turned on, the data voltage Vdata is applied to the second electrode N3 of the driving element DT. Therefore, a voltage Vdata-Vsam obtained by subtracting the sampling voltage Vsam from the data voltage Vdata is applied to the gate node N1 of the driving element DT.

Referring to FIGS. 1, 2 and 5, the display device 100 according to one or more example embodiments of the present disclosure includes the display panel 10, which includes the light-emitting element EL and the pixel circuit coupled to the light-emitting element DT. The pixel circuit includes the driving element DT for driving the light-emitting element EL, the sixth switching element T6 connected to the node N3 of the driving element DT, and the sampling capacitor Csam connected across the gate node of the driving element and the node N3 of the driving element. During a first sampling period (e.g., TP2), the sixth switching element T6 is configured to apply a sampling voltage Vsam to the node N3 of the driving element in response to a (n−1)-th second scan signal SC2(n−1). The sampling capacitor Csam is configured to store the sampling voltage. During the first sampling period (e.g., TP2), the gate node of the driving element DT is configured to be sampled based on a voltage obtained by adding the sampling voltage Vsam to a threshold voltage Vth of the driving element.

The display panel 10 of the display device 100 also includes the second switching element T2 connected to the node N3 of the driving element DT. The threshold voltage Vth of the driving element DT is for being sampled during the first sampling period (e.g., TP2) and a second sampling period (e.g., TP3). The pixel circuit is configured to cause sampling of the threshold voltage Vth of the driving element DT during the first sampling period, in response to the sixth switching element T6 being switched. The pixel circuit is configured to cause sampling of the threshold voltage Vth of the driving element DT during the second sampling period, in response to the second switching element T2 being switched.

In one or more examples, the second sampling period immediately follows the first sampling period.

In one or more examples, during the first sampling period, the sixth switching element T6 is configured to be turned on, and the second switching element T2 is configured to be turned off. During the second sampling period, the second switching element T2 is configured to be turned on, and the sixth switching element T6 is configured to be turned off.

In one or more examples, the sixth switching element T6 is configured to supply the sampling voltage Vsam across the node N3 and the gate node of the driving element DT. The second switching element T2 is configured to supply a data voltage Vdata to the node N3 of the driving element Dt. The driving element DT is configured to receive, at the gate node of the driving element, a voltage obtained by subtracting the sampling voltage Vsam from the data voltage Vdata.

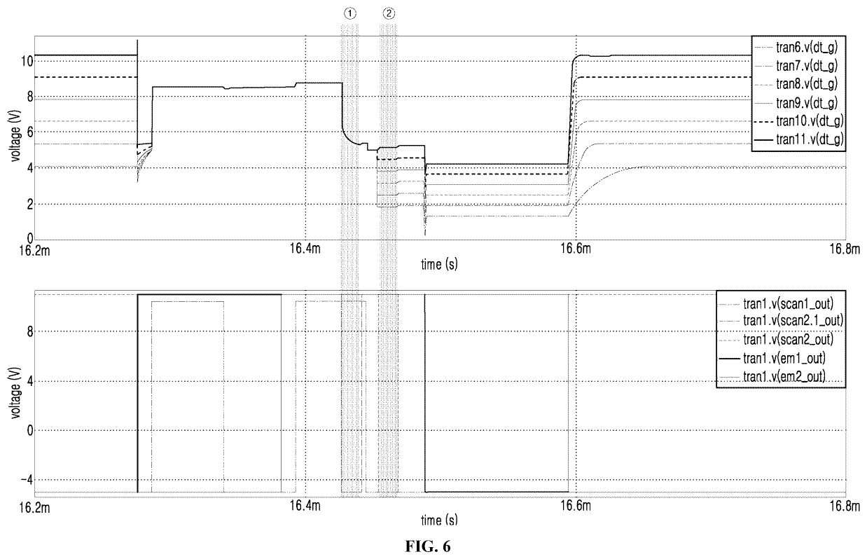

The display device 100 according to one or more example embodiments of the present disclosure may perform a sampling operation on the driving element DT in the second period TP2 and the third period TP3 as described above, as shown in FIG. 6. FIG. 6 is an operation timing graph showing a sampling period of the driving element according to one or more example embodiments of the present disclosure. As described above, a sampling operation according to the second period TP2 may be performed using the sixth switching element T6 connected to the second electrode N3 of the driving element DT. A sampling operation according to the third period TP3 may be performed using the second switching element T2 connected to the second electrode N3 of the driving element DT. Thus, a sampling time of the threshold voltage of the driving element DT may be extended and secured. This may reduce the pixel defect such as luminance non-uniformity of the pixels.

In one example, the display device 100 according to one or more example embodiments of the present disclosure may operate in the fourth period TP4.

The fourth period TP4 may be a light-emission period. The fourth period TP4 refers to a period in which the sampled threshold voltage Vth is cancelled, and the light-emitting element EL emits light under the driving current corresponding to the sampled data voltage.

Each of the (n−2)-th light-emission signal EM(n−2) and the n-th light-emission signal EM(n) is a low level voltage, while each of the (n−1)-th second scan signal SC2(n−1), the n-th second scan signal SC2(n), and the n-th first scan signal SC1(n) is a high level voltage.

The first switching element T1, the third switching element T3, the driving element DT, and the fourth switching element T4 are turned on, while the second switching element T2 and the fifth to seventh switching elements T5 to T7 are turned off.

As the third switching element T3 has been (or is) turned on, the high potential driving voltage EVDD is applied to the first electrode N2 and the gate electrode N1 of the driving transistor DT connected to the second node N2 through the third switching element T3. The driving current Id supplied from the driving transistor DT to the light-emitting element EL through the fourth switching element T4 is independent of a value of the threshold voltage Vth of the driving transistor DT. Thus, the threshold voltage Vth of the driving transistor DT is compensated for.

Afterwards, the display device 100 according to one or more example embodiments of the present disclosure operates for the hold period.

In the refresh period, a new data voltage Vdata is charged and the new data voltage Vdata is applied to the gate electrode of the driving transistor DT, while in the hold period, the data voltage Vdata of the refresh period is maintained. Therefore, unlike the refresh period, the hold period may not require the first to third periods TP1 to TP3. It may suffice that a single on-bias stress (OBS) operation is performed for the hold period.

According to one example embodiment of the present disclosure, as shown in FIG. 2, the seventh transistor T7 may be electrically connected to and disposed between the gate electrode N1 and the source electrode N3 of the driving transistor DT.

That is, the second electrode N1 of the seventh transistor T1 may be connected to the first node N1 as the gate electrode of the driving transistor DT, and the first electrode N3 of the seventh transistor T7 may be in contact with the third node N3 as the source electrode of the driving transistor DT.

In this regard, the seventh transistor T7 operates based on the (n−2)-th light-emission signal EM(n−2) to control the voltage Vgs (gate-source voltage) across the gate node and the source node of the driving transistor DT.

Accordingly, the gate node N1 of the driving element DT under a main stress condition of PBTS (Positive Bias Temperature Stress) may be sampled by the seventh transistor T7 based on a voltage Vth+Vsam obtained by adding the sampling voltage Vsam to the threshold voltage Vth.

The seventh transistor T7 may adjust the gate voltage Vg of the driving transistor DT to the previous frame voltage, such that the PBTS may be reduced.

According to one or more example embodiments of the present disclosure, the seventh transistor T7 adjusts the gate voltage Vg of the driving transistor DT to the previous frame voltage, such that a current value of the light-emitting element EL may be improved compared to that of a conventional pixel.

Therefore, when operating the display device 100, a voltage difference is not generated between a previous frame voltage and the gate voltage Vg of the driving transistor by the high voltage of the (n−2)-th light-emission signal EM(n−2). Therefore, the driving transistor for sampling is not subjected to the PBTS.

Accordingly, the threshold voltage Vth of the driving transistor may be prevented from being positively shifted, and kickback may be reduced to prevent a low-gray level stain of the pixel due to decrease in the current and luminance.

The seventh thin-film transistor T7 as the low-temperature polycrystalline silicon (LTPS) may be disposed between and connected to the gate electrode and the source electrode of the driving transistor, such that the voltage difference of gate voltage that causes the bias stress may be reduced to the previous frame voltage.

Therefore, the kickback caused by the bias stress of the driving transistor may be reduced such that an amount of shift of the oxide transistor may be reduced, and thus, the occurrence of the low-gray level stain in the pixel may be prevented.

In addition, the occurrence of the low-gray level stain may be suppressed, such that the quality of the product may be improved, and the reliability thereof may be secured, thus making it possible to realize a narrow bezel.

As described above, according to one or more example embodiments of the present disclosure, the display panel and the display device including the same in which the sampling transistor and the sampling capacitor for additional sampling are additionally disposed between the light-emitting element and the driving element of the display panel to secure the sufficient sampling time of the threshold voltage of the driving element may be realized.

In one or more aspects, the terms “first,” “second” and the like in connection with various elements (e.g., switching elements, electrodes, nodes, periods) may be used simply to distinguish one element from another. For example, a first element may denote a second element, and, similarly, a second element may denote a first element.

Without limiting the scope of the present disclosure or the claims, the following examples are provided by way of illustration. In an example, a first switching element may denote a fifth switching element T5. A second switching element may denote a sixth switching element T6. A third switching element may denote a seventh switching element T7. A fourth switching element may denote a first switching element T1. A fifth switching element may denote a third switching element T3. A sixth switching element may denote a fourth switching element T4. A seventh switching element may denote a second switching element T2. In another example, a fourth switching element may denote a second switching element T2. In yet another example, a first switching element may denote a sixth switching element T6. In one or more examples, a first electrode may denote a second electrode, and, similarly, a second electrode may denote a first electrode. In one or more examples, a first node may denote a second node, and, similarly, a second node may denote a first node.

In one or more examples, an element (e.g., switching element, a light-emission driver, a scan driver, a data driver, and/or a controller) may be or may include one or more elements (e.g., one or more switching elements, one or more light-emission drivers, one or more scan drivers, one or more data drivers, and/or one or more controllers, respectively).

In one or more examples, each of the notations (n), n-th, and the like may be a natural number.

In one or more aspects, sampling of a threshold voltage may include measuring and/or determining a threshold voltage. For example, during a sampling period, a circuit may measure the threshold voltage Vth of a driving element DT to calibrate the control signals accordingly. Further, sampling of a gate node of a driving element DT may include measuring, adjusting or setting a voltage at the gate node to determine or influence the operation of the driving element DT or to control the behavior of the driving element DT. The sampling processes can ensure that the driving element DT is accurately controlled by setting its gate voltage to a value that compensates for variations in its threshold voltage, enabling stable and consistent display pixel behavior.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above is not restrictive but illustrative in all respects. Thus, the scope of protection of the present disclosure should be construed based on the following claims, and all technical features within the scope of equivalents thereof should be construed as being included within the scope of the present disclosure.

What is claimed is:

1. A display panel, comprising:
a light-emitting element;
a driving element for driving the light-emitting element;
a first switching element configured to be switched to apply an initialization voltage to each of a first electrode of the light-emitting element and a gate electrode of the driving element; and
a second switching element configured to be switched to apply a sampling voltage across a first electrode of the driving element and the gate electrode of the driving element.

2. The display panel of claim 1, wherein the first switching element is an N-type thin-film transistor,
wherein the first switching element is configured to receive the initialization voltage at a first electrode of the first switching element,
wherein the first electrode of the light-emitting element is connected to a second electrode of the first switching element,
wherein the first switching element is configured to receive an (n−2)-th light-emission signal at a gate electrode of the first switching element, and
wherein n is a natural number.

3. The display panel of claim 1, wherein the second switching element is a P-type thin-film transistor,
wherein the second switching element is configured to receive the sampling voltage at a first electrode of the second switching element,
wherein the first electrode of the driving element is connected to a second electrode of the second switching element,
wherein the second switching element is configured to receive an (n−1)-th scan signal at a gate electrode of the second switching element, and
wherein n is a natural number.

4. The display panel of claim 1, wherein a third switching element and a sampling capacitor are connected to and disposed between the first electrode and the gate electrode of the driving element.

5. The display panel of claim 4, wherein the first electrode of the driving element is connected to a first electrode of the sampling capacitor,
wherein a first electrode of the third switching element is connected to a second electrode of the sampling capacitor,
wherein the third switching element is an N-type thin-film transistor,
wherein a second electrode of the first switching element is connected to a second electrode of the third switching element,
wherein the third switching element is configured to receive an (n−2)-th light-emission signal at a gate electrode of the third switching element, and
wherein n is a natural number.

6. The display panel of claim 1, wherein a fourth switching element is connected to and disposed between the gate electrode and a second electrode of the driving element, and
wherein a fifth switching element is connected to the second electrode of the driving element.

7. The display panel of claim 6, wherein the fourth switching element is an N-type thin-film transistor,
wherein the second electrode of the driving element is connected to a first electrode of the fourth switching element,
wherein the gate electrode of the driving element is connected to a second electrode of the fourth switching element,
wherein the fourth switching element is configured to receive a first scan signal at a gate electrode of the fourth switching element,
wherein the fifth switching element is a P-type thin-film transistor,
wherein a potential driving voltage line is connected to a first electrode of the fifth switching element,
wherein the second electrode of the driving element is connected to a second electrode of the fifth switching element,
wherein the fifth switching element is configured to receive an n-th light-emission signal at a gate electrode of the fifth switching element, and
wherein n is a natural number.

8. The display panel of claim 1, wherein a sixth switching element is connected to and disposed between the light-emitting element and the driving element, and
wherein a seventh switching element is connected to and disposed between the sixth switching element and the driving element.

9. The display panel of claim 8, wherein the seventh switching element is configured to receive a data voltage at a first electrode of the seventh switching element,
wherein a first electrode of the sixth switching element is connected to a second electrode of the seventh switching element,
wherein the seventh switching element is configured to receive an n-th second scan signal at a gate electrode of the seventh switching element,
wherein the sixth switching element is configured to receive an (n−2)-th light-emission signal at a gate electrode of the sixth switching element,
wherein the first electrode of the light-emitting element is connected to a second electrode of the sixth switching element, and
wherein each n is a natural number.

10. A display device, comprising:
a display panel including:
a light-emitting element;
a driving element for driving the light-emitting element;
a first switching element configured to be switched to apply an initialization voltage to each of a first electrode of the light-emitting element and a gate electrode of the driving element; and
a second switching element configured to be switched to apply a sampling voltage across a first electrode of the driving element and the gate electrode of the driving element;
a light-emission driver configured to supply a light-emission signal to the first switching element;
a scan driver configured to supply a scan signal to the second switching element;
a data driver configured to supply a data voltage to a connection node of the light-emitting element and the driving element; and
a controller configured to control the light-emission driver, the scan driver, and the data driver.

11. The display device of claim 10, wherein during a first period, the light-emission driver is configured to apply an (n−2)-th light-emission signal to the first switching element to turn on the first switching element,
wherein responsive to the first switching element being turned on, the first switching element is configured to apply the initialization voltage to each of the light-emitting element and the driving element to cause the first electrode of the light-emitting element and the gate electrode of the driving element to be initialized, and
wherein n is a natural number.

12. The display device of claim 10, wherein during a second period, the scan driver is configured to apply an (n−1)-th second scan signal to the second switching element to turn on the second switching element,
wherein responsive to the second switching element being turned on, the second switching element is configured to apply the sampling voltage to the first electrode of the driving element to cause the gate electrode of the driving element to be sampled based on a voltage obtained by adding the sampling voltage to a threshold voltage of the driving element, and
wherein n is a natural number.

13. The display device of claim 12, wherein a third switching element and a sampling capacitor are connected to and disposed between the first electrode of the driving element and the gate electrode of the driving element, and
wherein the sampling capacitor connected to the first electrode of the driving element, is configured to store the sampling voltage.

14. The display device of claim 13, wherein a fourth switching element is connected to the first electrode of the driving element,
wherein during a third period, the scan driver is configured to apply an n-th second scan signal to the fourth switching element to turn on the fourth switching element, and
wherein responsive to the fourth switching element being turned on, the driving element is configured to receive a data voltage at the first electrode of the driving element.

15. The display device of claim 14, wherein the driving element is configured to receive, at the gate electrode of the driving element, a voltage obtained by subtracting the sampling voltage from the data voltage.

16. A display device, comprising:
a light-emitting element;
a driving element for driving the light-emitting element;
a first switching element connected to a node of the driving element; and
a sampling capacitor connected across a gate node of the driving element and the node of the driving element,
wherein:
the first switching element is configured to apply a sampling voltage to the node of the driving element in response to a scan signal;
the sampling capacitor is configured to store the sampling voltage; and
the gate node of the driving element is configured to be sampled based on a voltage obtained by adding the sampling voltage to a threshold voltage of the driving element.

17. The display device of claim 16, further comprising:
a second switching element connected to the node of the driving element,
wherein:
a pixel circuit comprises the driving element, the first switching element, and the second switching element;
the threshold voltage of the driving element is for being sampled during a first sampling period and a second sampling period;
the pixel circuit is configured to cause sampling of the threshold voltage of the driving element during the first sampling period, in response to the first switching element being switched; and
the pixel circuit is configured to cause sampling of the threshold voltage of the driving element during the second sampling period, in response to the second switching element being switched.

18. The display device of claim 17, wherein the second sampling period immediately follows the first sampling period.

19. The display device of claim 17, wherein:
during the first sampling period, the first switching element is configured to be turned on, and the second switching element is configured to be turned off; and
during the second sampling period, the second switching element is configured to be turned on, and the first switching element is configured to be turned off.

20. The display device of claim 17, wherein:
the second switching element is configured to supply a data voltage to the node of the driving element; and
the driving element is configured to receive, at the gate node of the driving element, a voltage obtained by subtracting the sampling voltage from the data voltage.
